(19) United States
(12) Patent Application Publication
(10) Pub. No.: US 2025/0103865 A1
(43) Pub. Date: Mar. 27, 2025

(54) CONVOLUTION LAYER CONVERSION APPARATUS, CONVOLUTION LAYER CONVERSION METHOD, AND PROGRAM

(71) Applicant: NEC Corporation, Minato-ku, Tokyo (JP)

(72) Inventor: Seiya SHIBATA, Tokyo (JP)

(73) Assignee: NEC Corporation, Minato-ku, Tokyo (JP)

(21) Appl. No.: 18/728,124

(22) PCT Filed: Jan. 19, 2022
(86) PCT No.: PCT/JP2022/001756

§ 371 Date: Jul. 11, 2024

(51) Int. Cl. G06N 3/0464

(52) U.S. Cl. CPC G06N 3/0464

(57) ABSTRACT

The convolution layer conversion apparatus includes: a convolution layer detection part that detects a convolution layer containing a large kernel of a predetermined kernel size or larger in a neural network model structure provided as an input; and a convolution layer decomposition part that converts the convolution layer into a convolution layer containing a combination of a plurality of small kernels obtained by decomposing the detected large kernel into a plurality of small kernels whose kernel sizes is smaller than the predetermined size and an aggregate convolution layer that aggregates results from the convolution layer containing the combination of the plurality of small kernels, and outputs a neural network model structure in which the convolution layer is converted.

### TECHNICAL FIELD

The present invention relates to a convolution layer conversion apparatus, a convolution layer conversion method, and a program.

### BACKGROUND ART

In a convolution layer used in a neural network (NN) model, kernels of various sizes are used. Recently, the use of kernels of sizes 1×1 and 3×3 has become mainstream while the use of kernels of sizes 7×7 and 5×5 tends to be less common. In addition, there is a trend that a plurality of consecutive kernels of a size 3×3 are used instead of a single-layer kernel of size 7×7 or 5×5 in a convolution layer respectively. However, for instance, when a single-layer kernel of size 7×7 is structurally changed to two layers of 3×3 kernels, they may seem semantically similar in some cases, but the computational content and the results thereof are often not equivalent.

Meanwhile, a kernel of a size 7×7 may be used in a convolution layer in some cases. This is because larger kernels sometimes make the training easier, and 7×7 or 5×5 kernels are commonly used in older neural networks for which achieved accuracy is well-known.

Patent Literature (PTL) 1 relates to an information processing apparatus that efficiently performs a generation process of neighborhood matrix image data for a convolution operation.

Patent Literature 2 relates to an apparatus for detecting variants of malicious code based on neural network learning.

Patent Literature 3 relates to a DNN weight saving apparatus that allows to efficiently reduce weight of a convolution layer included in a CNN.

Patent Literature 4 relates to a neural network learning model generation apparatus.

Patent Literature 5 relates to a neural network apparatus.

### CITATION LIST

### Patent Literature

PTL1: Japanese Patent Kokai Publication No. 2018-120549A
PTL2: Japanese Patent Kohyo Publication No. 2019-527447A
PTL3: Japanese Patent Kokai Publication No. 2020-087288A
PTL4: Japanese Patent Kokai Publication No. 2020-107042A
PTL5: Japanese Patent Sai-Kohyo Publication No. WO-A1-2018/016608

### SUMMARY

### Technical Problem

The following analysis is provided by the present invention.

Using a kernel of a size 7×7 or a size 5×5 in a convolution layer, however, may slow down the execution speed when the convolution layer is implemented. In other words, using kernel of a size 7×7 or a size 5×5 can lead to more than just an increase in the computational complexity compared to smaller sized kernels such as 3×3 ones; it can also result in a slower implementation speed. This is due to the degree of optimization of the kernel, for instance, a simple and well-known kernel of a size 3×3 has a higher degree of optimization, and due to a problem of the design of the device or software library used for implementation.

It is an object of the present invention to provide a convolution layer conversion apparatus, a convolution layer conversion method, and a program that contribute to improving the execution speed during the implementation of a convolution layer in a neural network model.

### Solution to Problem

According to a first aspect of the present invention, there can be provided a convolution layer conversion apparatus including:
a convolution layer detection part that detects a convolution layer containing a large kernel whose kernel size is a predetermined size or larger in a neural network model structure provided as an input; and a convolution layer decomposition part that converts the convolution layer containing the large kernel into a convolution layer containing a combination of a plurality of small kernels whose kernel sizes are smaller than the predetermined size decomposed from the large kernel and an aggregate convolution layer that aggregates convolution results from the convolution layer containing the combination of the plurality of small kernels, and outputs a neural network model structure in which the convolution layer containing the large kernel is converted.

According to a second aspect of the present invention, there can be provided a convolution layer conversion method executed by a computer comprising a processor and a storage device, the convolution layer conversion method including:
a step of detecting a convolution layer containing a large kernel whose kernel size is a predetermined size or larger in a neural network model structure provided as an input; and a step of converting the convolution layer containing the large kernel into a convolution layer containing a combination of a plurality of small kernels whose kernel sizes are smaller than the predetermined size decomposed from the large kernel and an aggregate convolution layer that aggregates convolution results from the convolution layer containing the combination of the plurality of small kernels and outputting a neural network model structure in which the convolution layer containing the large kernel is converted.

According to a third aspect of the present invention, there can be provided a program causing a computer to execute:
a process of detecting a convolution layer containing a large kernel whose kernel size is a predetermined size or larger in a neural network model structure provided as an input; and
a process of converting the convolution layer containing the large kernel into a convolution layer containing a combination of a plurality of small kernels whose kernel sizes are smaller than the predetermined size decomposed from the large kernel and an aggregate convolution layer that aggregates convolution results from the convolution layer containing the combination of the plurality of small kernels and outputting a neural network model structure in which the convolution layer containing the large kernel is converted. Further, these programs can be stored in a computer-readable storage medium. The storage medium may be a non-transient one such as a semiconductor memory, a hard disk, a magnetic recording medium, an optical recording medium, and the like. The present invention can also be realized as a computer program product.

### Advantageous Effects of Invention

According to the present invention, there can be provided a convolution layer conversion apparatus, a convolution layer conversion method, and a program that contribute to improving the execution speed during the implementation of a convolution layer in a neural network model.

### BRIEF DESCRIPTION OF DRAWINGS

FIG. 1 is a drawing illustrating an example of the configuration of a convolution layer conversion apparatus according to an example embodiment of the present invention.

FIG. 2 is a drawing illustrating an example of the configuration of a convolution layer conversion apparatus according to a first example embodiment of the present invention.

FIG. 3 is a drawing illustrating examples of a large kernel and a plurality of small kernels decomposed from the large kernel according to the first example embodiment of the present invention.

FIG. 4 is a drawing illustrating an example of the convolution operation between input data and the convolution layer of the large kernel of the first example embodiment of the present invention.

FIG. 5 is a drawing illustrating an example of the structure of a convolution layer obtained by converting the convolution layer containing the large kernel into a convolution layer containing a combination of the plurality of small kernels and an aggregate convolution layer according to the first example embodiment of the present invention.

FIG. 6 is a drawing illustrating an example of the operation performed on the input data by a convolution part of a decomposed small kernel and an aggregate convolution part of the first example embodiment of the present invention.

FIG. 7 is a drawing illustrating an example of the operation performed on the input data by a convolution part of a decomposed small kernel and an aggregate convolution part of the first example embodiment of the present invention.

FIG. 8 is a drawing illustrating an example of the operation performed on the input data by a convolution part of a decomposed small kernel and an aggregate convolution part of the first example embodiment of the present invention.

FIG. 9 is a drawing illustrating an example of the operation performed on the input data by a convolution part of a decomposed small kernel and an aggregate convolution part of the first example embodiment of the present invention.

FIG. 10 is a drawing illustrating an example of the configuration of a convolution layer conversion apparatus according to a second example embodiment of the present invention.

FIG. 11 is a drawing illustrating an example of the structure of a converted convolution layer of the second example embodiment of the present invention in which a padding processing part is provided by an adjustment section of the second example embodiment of the present invention in each of the convolution layer containing the combination of the plurality of small kernels and the aggregate convolution layer.

FIG. 12 is a drawing illustrating an example of the control operation of the padding processing part provided by the adjustment section of the second example embodiment of the present invention in the convolution layer containing the combination of the small kernels and an example of the control operation of the padding processing part provided by the adjustment section in the aggregate convolution layer.

FIG. 13 is a drawing illustrating another example of a decomposition method for decomposing a large kernel into a plurality of small kernels according to a third example embodiment of the present invention.

FIG. 14 is a drawing illustrating examples of the decomposed small kernels and aggregate kernels respectively corresponding to the small kernels according to the third example embodiment of the present invention.

FIG. 15 is a drawing illustrating other examples of the decomposed small kernels and aggregate kernels respectively corresponding to the small kernels according to the third example embodiment of the present invention.

FIG. 16 is a drawing illustrating examples of computation graphs before and after the decomposition according to the third example embodiment of the present invention.

FIG. 17 is a drawing illustrating another example of computation graphs before and after the decomposition according to the third example embodiment of the present invention.

FIG. 18 is a drawing illustrating an example of the configuration of a decomposition method selection section of a convolution layer decomposition part of a convolution layer conversion apparatus according to a fourth example embodiment of the present invention.

FIG. 19 is a drawing showing an example of target device information stored in an on-device execution speed database of the fourth example embodiment of the present invention.

FIG. 20 is a drawing illustrating the configuration of a computer constituting the convolution layer conversion apparatus of the present invention.

### EXAMPLE EMBODIMENTS

First, an outline of an example embodiment of the present invention will be given with reference to the drawings. It should be noted that the drawing reference signs in the outline are given to each element for convenience as an example to facilitate understanding and are not intended to limit the present invention to the illustrated aspects. Further, connection lines between blocks in the drawings referred to in the following description can be both bidirectional and unidirectional. A unidirectional arrow schematically shows the main flow of a signal (data) and does not exclude bidirectionality.

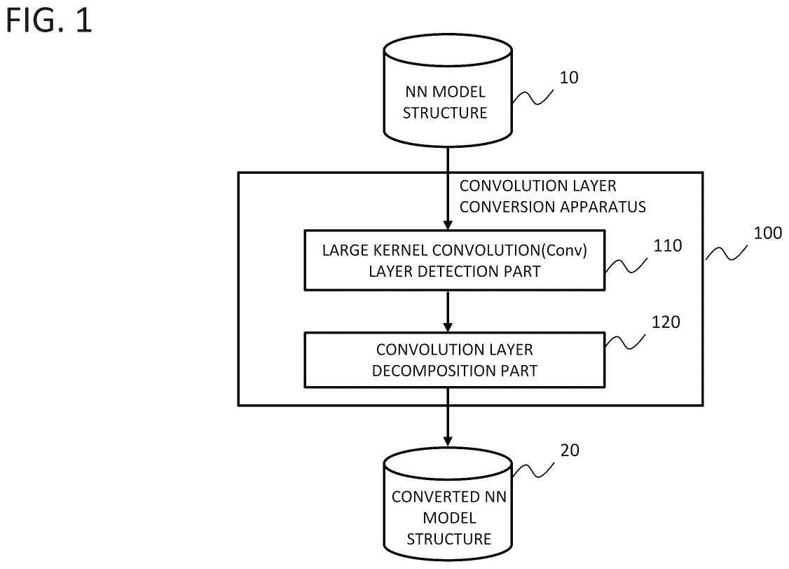

FIG. 1 is a drawing illustrating an example of the configuration of a convolution layer conversion apparatus according to an example embodiment of the present invention. With reference to FIG. 1, the convolution layer conversion apparatus 100 of the example embodiment of the present invention includes a large kernel convolution (Conv) layer detection part 110 (convolution layer detection part) and a convolution layer decomposition part 120. The large kernel convolution (Conv) layer detection part 110 detects a convolution layer containing a large kernel whose kernel size is a predetermined size or larger in a neural network (NN) model structure 10 provided as an input. The convolution layer decomposition part 120 converts the convolution layer containing the large kernel into a convolution layer containing a combination of a plurality of small kernels whose kernel sizes are smaller than the predetermined size decomposed from the large kernel and an aggregate convolution layer that aggregates the convolution results from the convolution layer containing the combination of the plurality of small kernels and outputs a neural network model structure 20 in which the convolution layer containing the large kernel is converted.

As described, since the convolution layer containing the large kernel is converted into the convolution layer containing the combination of the plurality of small kernels decomposed from the large kernel and the aggregate convolution layer, optimization techniques related to a convolution of a kernel of a size 3×3 such as the Winograd optimization or the like that can speed up doubly may be utilized for a convolution of the input data and each of the small kernels. Further, it is possible to make the most of circuits and implementations for high-speed execution of convolution layers such as hardware circuits and software libraries optimized for convolutions of kernels of a size 3×3 and possible to further utilize a sparsity-leveraging acceleration mechanism that skips multiplication by a zero value if it is available. This allows to speed up an execution speed of a convolution.

As described above, according to the example embodiment of the present invention, there can be provided a convolution layer conversion apparatus that contributes to improving the execution speed during the implementation of a convolution layer in a neural network model.

### First Example Embodiment

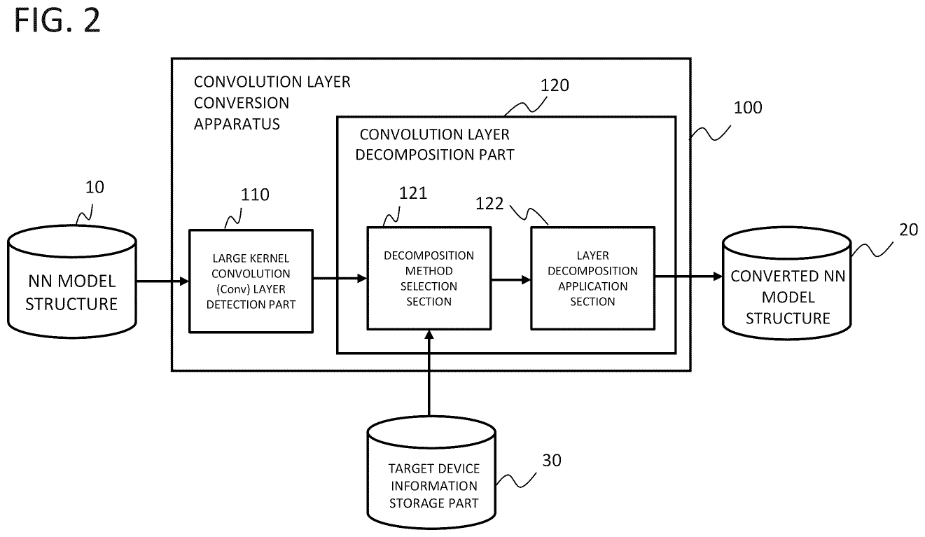

Next, the following describes a convolution layer conversion apparatus according to a first example embodiment of the present invention with reference to the drawings. FIG. 2 is a drawing illustrating an example of the configuration of the convolution layer conversion apparatus according to the first example embodiment of the present invention. In FIG. 2, components with the same reference signs as those in FIG. 1 indicate the same components, and the descriptions thereof will be omitted.

With reference to FIG. 2, the convolution layer conversion apparatus 100 according to the first example embodiment of the present invention includes the large kernel convolution (Conv) layer detection part 110 (convolution layer detection part) and the convolution layer decomposition part 120, and the convolution layer decomposition part 120 includes a decomposition method selection section 121 and a layer decomposition application section 122. The convolution layer conversion apparatus 100 accepts the neural network (NN) model structure 10 as an input and outputs the converted neural network model structure 20. Further, to the decomposition method selection section 121 of the convolution layer decomposition part 120, a target device information storage part 30 is connected to provide target device information as an input.

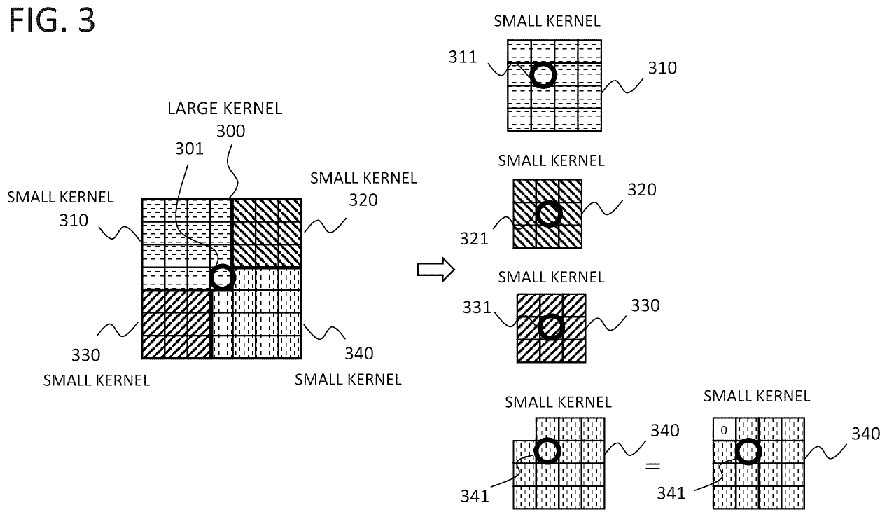

The large kernel convolution layer detection part 110 detects a convolution layer containing a large kernel whose kernel size is a predetermined size or larger in the neural network (NN) model structure 10 provided as an input. FIG. 3 is a drawing illustrating examples of a large kernel of the first example embodiment of the present invention and a plurality of small kernels whose kernel sizes are small decomposed from the large kernel.

In FIG. 3, it is assumed that the neural network (NN) model structure 10 provided as an input includes a convolution layer containing a kernel of a kernel size 7×7 (referred to as the large kernel 300 hereinafter). Here, with the predetermined size being a 7×7 kernel size, the large kernel convolution layer detection part 110 detects a convolution layer containing the large kernel 300 of a kernel size 7×7 in the neural network (NN) model structure 10 provided as an input.

First, the following describes the convolution in the convolution layer containing the large kernel 300 in the neural network model structure 10 without performing the decomposition of the convolution layer according to the present invention.

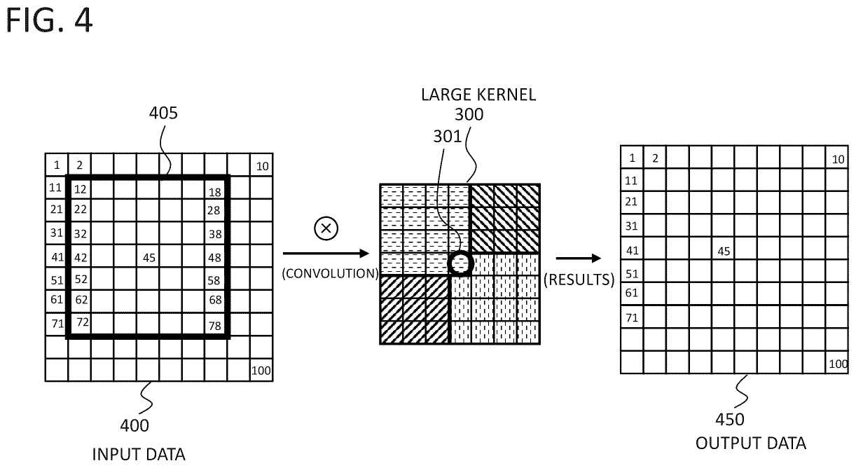

FIG. 4 is a drawing illustrating an example of the convolution of input data 400 and the convolution layer of the large kernel 300 without performing the decomposition of the convolution layer according to the present invention. Let us assume that the input data 400 is two-dimensional data containing elements 1 to 100. Note that the numerals 1 to 100 on the input data 400 indicate positions on the input data 400, not values of each element, and as an example, the top left corner is 1, and the numbers increase to the right and downward, reaching 100 at the bottom right corner. Convolution is performed between data located in a range 405 on the input data 400 (the positions 12 to 18, 22 to 28, 32 to 38, 42 to 48, 52 to 58, 62 to 68, and 72 to 78) and the large kernel 300. In FIG. 4, the symbol with an “x” inside a circle represents convolution; this also applies to the other drawings. A convolution result shown in FIG. 4 corresponds to the position 45 on the input data 400 multiplied by a center 301 of the large kernel 300 and is outputted to the position 45 on output data 450. In other words, as an example, the convolution of the input data 400 and the large kernel 300 is computed as an output corresponding to the center 301 of the large kernel 300 while having the center 301 of the large kernel 300 move from the position 1 to the position 100 over the input data 400.

Next, the following describes the operation of the decomposition method selection section 121 of the convolution layer decomposition part 120 of the convolution layer conversion apparatus 100 according to the first example embodiment of the present invention. The decomposition method selection section 121 selects a method for decomposing the large kernel 300 in the convolution layer containing the detected large kernel 300 (a kernel of a kernel size 7×7). The decomposition method is selected on the basis of the target device information in the target device information storage part 30. The target device information in the target device information storage part 30 includes execution speed information indicating the execution speed of running a convolution layer containing a combination of a plurality of small kernels (decomposition candidates obtained by the decomposition method) on a target device, or memory usage information indicating the memory usage of running a convolution layer containing a combination of a plurality of small kernels (decomposition candidates obtained by the decomposition method) on a target device. Decomposing a large kernel into a plurality of small ones may increase the memory usage during implementation, however, in some cases, the memory usage needs to be maintained at a constant level. By selecting the decomposition method while taking into consideration the memory usage information, in addition to the execution speed information, it is possible to maintain the memory usage at a constant level and increase the execution speed.

In the first example embodiment of the present invention, as an example, we will assume that the selected decomposition method is one that decomposes the large kernel 300 into a plurality of small kernels whose kernel sizes are smaller than the predetermined size 7×7, as shown in FIG. 3, according to the target device information.

Next, the following describes an example of the operation of the layer decomposition application section 122 of the convolution layer decomposition part 120. The layer decomposition application section 122 decomposes the detected large kernel 300 of the convolution layer containing the large kernel 300 into a plurality of small kernels 310, 320, 330, and 340, as shown in FIG. 3, according to the decomposition method selected by the decomposition method selection section 121.

With reference to FIG. 3, the large kernel 300 is a kernel whose kernel size is a size 7×7 with the center 301, and the layer decomposition application section 122 decomposes the large kernel 300 into the small kernel 310 of a kernel size 4×4 having a center 311, the small kernel 320 of a kernel size 3×3 having a center 321, the small kernel 330 of a kernel size 3×3 having a center 331, and the small kernel 340 of a kernel size 4×4 having a center 341. Note that the small kernel 340 does not have an element at its top-left corner, or a value of zero is assigned thereto in order to avoid any overlapping element with the small kernel 310. Further, the decomposition method for decomposing a large kernel into a plurality of small kernels according to the present invention is not limited to the decomposition method described above.

Next, the layer decomposition application section 122 outputs the neural network model structure 20 obtained by converting the convolution layer containing the large kernel 300 into a convolution layer containing a convolution layer containing a combination of a plurality of the decomposed small kernels 310, 320, 330, and 340 and an aggregate convolution layer aggregating the results of the convolution layer containing the combination of the plurality of the small kernels.

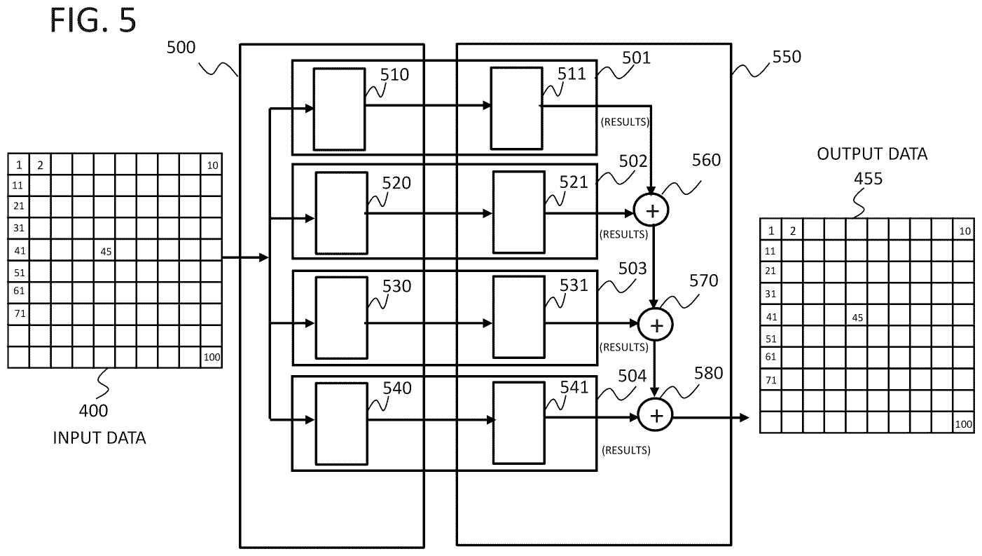

FIG. 5 is a drawing illustrating an example of the structure of the convolution layer, converted from the convolution layer containing the large kernel 300 of the first example embodiment of the present invention, containing the convolution layer 500 containing the combination of the plurality of small kernels 310, 320, 330, and 340 and the aggregate convolution layer 550 aggregating the results of the convolution layer containing the combination of the plurality of small kernels 310, 320, 330, and 340.

Next, with reference to the drawings, the following describes the structures and operations of the convolution layer 500 containing the combination of the plurality of small kernels 310, 320, 330, and 340 and the aggregate convolution layer 550.

It should be noted that the convolution result of the input data 400, the convolution layer 500 containing the combination of the plurality of small kernels, and the aggregate convolution layer 550 matches the convolution result of the input data 400 and the large kernel 300, except for part of the periphery of the output data.

With reference to FIG. 5, the convolution layer 500 containing the combination of the plurality of small kernels includes small kernel convolution parts 510, 520, 530, and 540, and the aggregate convolution layer 550 includes aggregate convolution parts 511, 521, 531, and 541 and addition parts 560, 570, and 580. Here, in order to facilitate the description, let us say that a block 501 includes the small kernel convolution part 510 and the aggregate convolution part 511, a block 502 includes the small kernel convolution part 520 and the aggregate convolution part 521, a block 503 includes the small kernel convolution part 530 and the aggregate convolution part 531, and a block 504 includes the small kernel convolution part 540 and the aggregate convolution part 541.

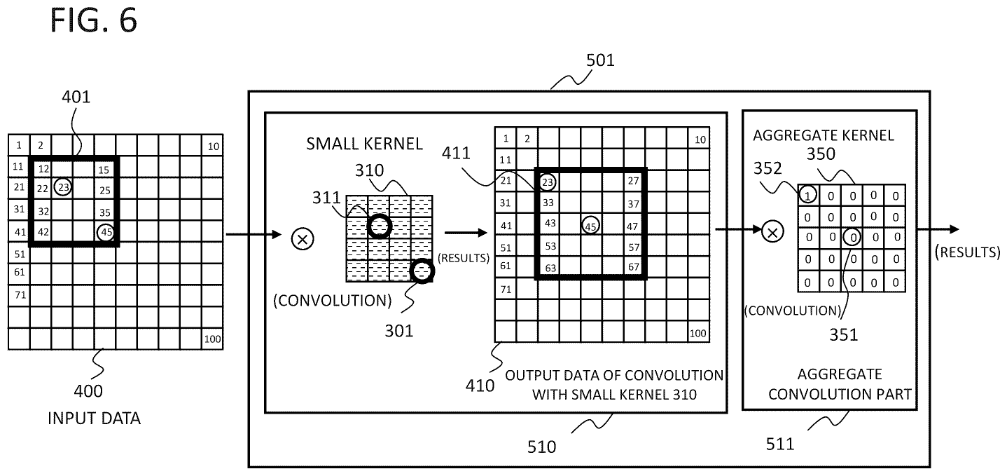

Next, the following describes the structure and the operation of each of the blocks 501, 502, 503, and 504 in FIG. 5 with reference to FIGS. 6 to 9.

FIG. 6 is a drawing illustrating the structure and the operation of the block 501. The block 501 includes the small kernel convolution part 510 that includes the small kernel 310 having the center 311 and the aggregate convolution part 511 that includes an aggregate kernel 350. The center 301 indicated by a circle on the small kernel 310 in FIG. 6 represents the relative position of the center 301 of the undecomposed large kernel 300 with respect to the center 311 of the decomposed small kernel 310.

As an example, the convolution of the input data 400 and the small kernel 310 is performed in the same manner as the convolution of the input data 400 and the large kernel 300, being computed as an output corresponding to the center 311 of the small kernel 310 while having the center 311 of the small kernel 310 move from the position 1 to the position 100 over the input data 400.

For instance, when the convolution of data located in a range 401 (the positions 12 to 15, 22 to 25, 32 to 35, and 42 to 45) on the input data 400 and the small kernel 310 having the center 311 is performed, the convolution result shown in FIG. 6 is outputted to the position 23 on output data 410 of the convolution with the small kernel 310, corresponding to the position 23, at which the center 311 of the small kernel 310 is located on the input data 400.

The output data 410 of the convolution with the small kernel 310 in FIG. 6 shows all the results obtained when the input data 400 is convolved with the small kernel 310 as described above.

Here, in order to compute the convolution when the center 301 of the large kernel 300 shown in FIG. 3 is at the position 45 of the input data 400 using the results of convolution with the decomposed small kernels 310, 320, 330, and 340, the results of the convolution with the small kernel 310 need the data at the position 23 on the output data 410 of the convolution with the small kernel 310. The data at the position 23 on the output data 410 is selected and outputted by convolution performed by the aggregate convolution part 511.

Next, the following describes the structure and the operation of the aggregate convolution part 511 with reference to FIG. 6. The aggregate convolution part 511 has the aggregate kernel 350 of a kernel size 5×5 having a center 351, and a value of one is assigned to a position 352 of the aggregate kernel 350 while a value of zero is assigned to each of other positions.

The convolution of the aggregate kernel 350 and the output data 410 of the convolution with the small kernel 310 is computed as an output corresponding to the center 351 of the aggregate kernel 350 while having, for instance, the center of the aggregate kernel 350 move from the position 1 to the position 100 over the output data 410 of the convolution with the small kernel 310.

As shown in FIG. 6, when the center 351 of the aggregate kernel 350 is at the position 45 on the output data 410 of the convolution with the small kernel 310, convolution is performed between data in a range 411 on the output data 410 of the convolution with the small kernel 310 (the positions 23 to 27, 33 to 37, 43 to 47, 53 to 57, and 63 to 67) and the aggregate kernel 350 of the aggregate convolution part 511.

As a result, the data at the position 23 on the output data 410 of the convolution with the small kernel 310 is outputted as the result of the block 501.

In other words, by convolving the input data 400 with the small kernel 310, and by convolving the output data 410 which is the result of the convolution of the small kernel 310 with the aggregate kernel 350, the necessary result obtained from the convolution of the input data 400 and the small kernel 310 is outputted as the result of block 501.

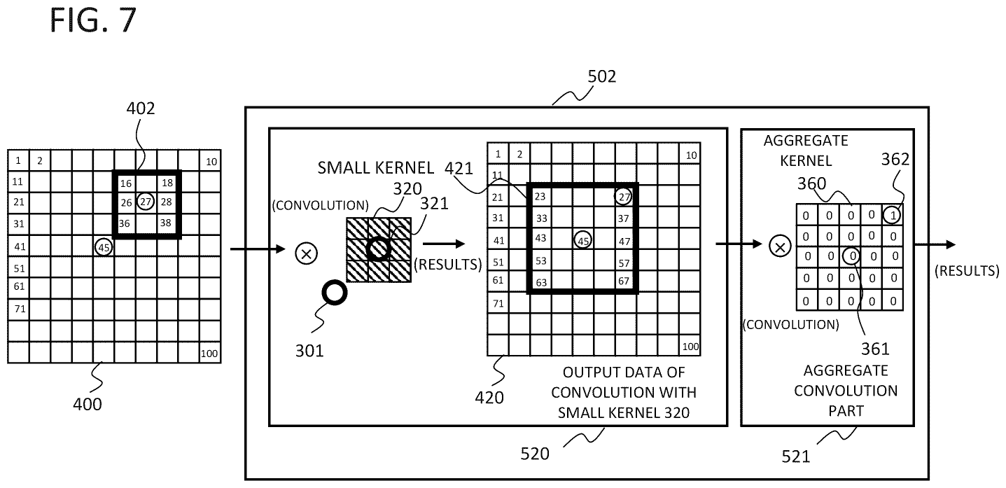

FIG. 7 is a drawing illustrating the structure and the operation of the block 502. The block 502 includes the small kernel convolution part 520 that includes the small kernel 320 having the center 321 and the aggregate convolution part 521 that includes an aggregate kernel 360. The center 301 indicated by a circle on the small kernel 320 in FIG. 7 represents the relative position of the center 301 of the undecomposed large kernel 300 with respect to the center 321 of the decomposed small kernel 320.

As an example, the convolution of the input data 400 and the small kernel 320 is performed in the same manner as the convolution of the input data 400 and the large kernel 300, being computed as an output corresponding to the center 321 of the small kernel 320 while having the center 321 of the small kernel 320 move from the position 1 to the position 100 over the input data 400.

For instance, when the convolution of data located in a range 402 (the positions 16 to 18, 26 to 28, and 36 to 38) on the input data 400 and the small kernel 320 having the center 321 is performed, the convolution result shown in FIG. 7 is outputted to the position 27 on output data 420 of the convolution with the small kernel 320, corresponding to the position 27, at which the center 321 of the small kernel 320 is located on the input data 400.

The output data 420 of the convolution with the small kernel 320 in FIG. 7 shows all the results obtained when the input data 400 is convolved with the small kernel 320 as described above.

Here, in order to compute the convolution when the center 301 of the large kernel 300 shown in FIG. 3 is at the position 45 of the input data 400 using the results of convolution with the decomposed small kernels 310, 320, 330, and 340, the results of the convolution with the small kernel 320 need the data at the position 27 on the output data 420 of the convolution with the small kernel 320. The data at the position 27 on the output data 420 is selected and outputted by convolution performed by the aggregate convolution part 521.

Next, the following describes the structure and the operation of the aggregate convolution part 521 with reference to FIG. 7. The aggregate convolution part 521 has the aggregate kernel 360 of a kernel size 5×5 having a center 361, and a value of one is assigned to a position 362 of the aggregate kernel 360 while a value of zero is assigned to each of other positions.

The convolution of the aggregate kernel 360 and the output data 420 of the convolution with the small kernel 320 is computed as an output corresponding to the center 361 of the aggregate kernel 360 while having, for instance, the center of the aggregate kernel 360 move from the position 1 to the position 100 over the output data 420 of the convolution with the small kernel 320.

As shown in FIG. 7, when the center 361 of the aggregate kernel 360 is at the position 45 on the output data 420 of the convolution with the small kernel 320, convolution is performed between data in a range 421 on the output data 420 of the convolution with the small kernel 320 (the positions 23 to 27, 33 to 37, 43 to 47, 53 to 57, and 63 to 67) and the aggregate kernel 360 of the aggregate convolution part 521.

As a result, the data at the position 27 on the output data 420 of the convolution with the small kernel 320 is outputted as the result of the block 502.

In other words, by convolving the input data 400 with the small kernel 320, and by convolving the output data 420 which is the result of the convolution of the small kernel 320 with the aggregate kernel 360, the necessary result obtained from the convolution of the input data 400 and the small kernel 320 is outputted as the result of block 502.

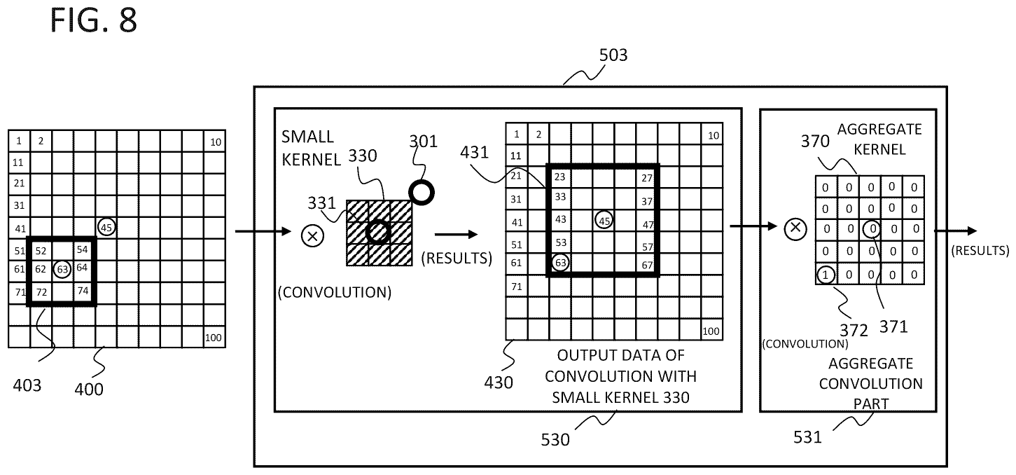

FIG. 8 is a drawing illustrating the structure and the operation of the block 503. The block 503 includes the small kernel convolution part 530 that includes the small kernel 330 having the center 331 and the aggregate convolution part 531 that includes an aggregate kernel 370. The center 301 indicated by a circle on the small kernel 330 in FIG. 8 represents the relative position of the center 301 of the undecomposed large kernel 300 with respect to the center 331 of the decomposed small kernel 330.

As an example, the convolution of the input data 400 and the small kernel 330 is performed in the same manner as the convolution of the input data 400 and the large kernel 300, being computed as an output corresponding to the center 331 of the small kernel 330 while having the center 331 of the small kernel 330 move from the position 1 to the position 100 over the input data 400.

For instance, when the convolution of data located in a range 403 (the positions 52 to 54, 62 to 64, and 72 to 74) on the input data 400 and the small kernel 330 having the center 331 is performed, the convolution result shown in FIG. 8 is outputted to the position 63 on output data 430 of the convolution with the small kernel 330, corresponding to the position 63, at which the center 331 of the small kernel 330 is located on the input data 400.

The output data 430 of the convolution with the small kernel 330 in FIG. 8 shows all the results obtained when the input data 400 is convolved with the small kernel 330 as described above.

Here, in order to compute the convolution when the center 301 of the large kernel 300 shown in FIG. 3 is at the position 45 of the input data 400 using the results of convolution with the decomposed small kernels 310, 320, 330, and 340, the results of the convolution with the small kernel 330 need the data at the position 63 on the output data 430 of the convolution with the small kernel 330. The data at the position 63 on the output data 430 is selected and outputted by convolution performed by the aggregate convolution part 531.

Next, the following describes the structure and the operation of the aggregate convolution part 531 with reference to FIG. 8. The aggregate convolution part 531 has the aggregate kernel 370 of a kernel size 5×5 having a center 371, and a value of one is assigned to a position 372 of the aggregate kernel 370 while a value of zero is assigned to each of other positions.

The convolution of the aggregate kernel 370 and the output data 430 of the convolution with the small kernel 330 is computed as an output corresponding to the center 371 of the aggregate kernel 370 while having, for instance, the center of the aggregate kernel 370 move from the position 1 to the position 100 over the output data 430 of the convolution with the small kernel 330.

As shown in FIG. 8, when the center 371 of the aggregate kernel 370 is at the position 45 on the output data 430 of the convolution with the small kernel 330, convolution is performed between data in a range 431 on the output data 430 of the convolution with the small kernel 330 (the positions 23 to 27, 33 to 37, 43 to 47, 53 to 57, and 63 to 67) and the aggregate kernel 370 of the aggregate convolution part 531.

As a result, the data at the position 63 on the output data 430 of the convolution with the small kernel 330 is outputted as the result of the block 503.

In other words, by convolving the input data 400 with the small kernel 330, and by convolving the output data 430 which is the result of the convolution of the small kernel 330 with the aggregate kernel 370, the necessary result obtained from the convolution of the input data 400 and the small kernel 330 is outputted as the result of block 503.

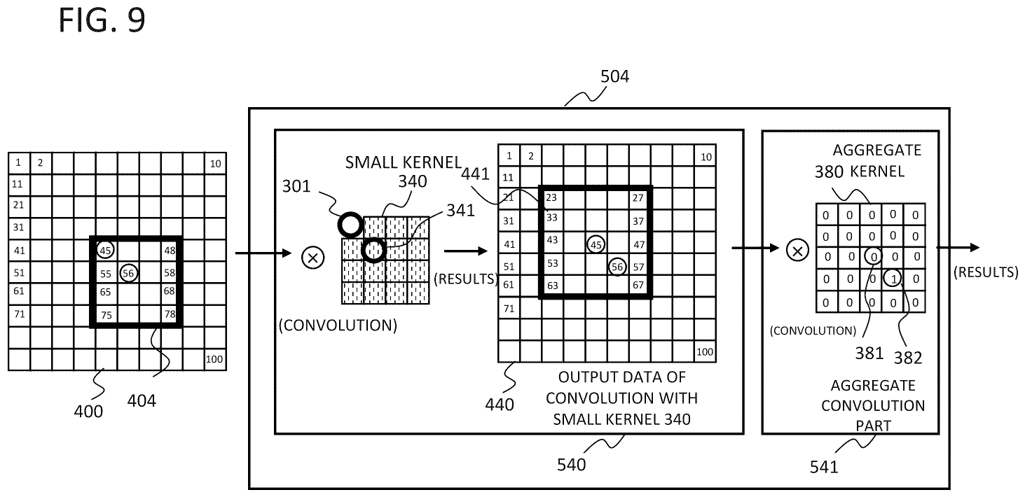

FIG. 9 is a drawing illustrating the structure and the operation of the block 504. The block 504 includes the small kernel convolution part 540 that includes the small kernel 340 having the center 341 and the aggregate convolution part 541 that includes an aggregate kernel 380. The center 301 indicated by a circle on the small kernel 340 in FIG. 9 represents the relative position of the center 301 of the undecomposed large kernel 300 with respect to the center 341 of the decomposed small kernel 340.

As an example, the convolution of the input data 400 and the small kernel 340 is performed in the same manner as the convolution of the input data 400 and the large kernel 300, being computed as an output corresponding to the center 341 of the small kernel 340 while having the center 341 of the small kernel 340 move from the position 1 to the position 100 over the input data 400.

For instance, when the convolution of data located in a range 404 (the positions 45 to 48, 55 to 58, 65 to 68, and 75 to 78) on the input data 400 and the small kernel 340 having the center 341 is performed, the convolution result shown in FIG. 9 is outputted to the position 56 on output data 440 of the convolution with the small kernel 340, corresponding to the position 56, at which the center 341 of the small kernel 340 is located on the input data 400.

The output data 440 of the convolution with the small kernel 340 in FIG. 9 shows all the results obtained when the input data 400 is convolved with the small kernel 340 as described above.

Here, in order to compute the convolution when the center 301 of the large kernel 300 shown in FIG. 3 is at the position 45 of the input data 400 using the results of convolution with the decomposed small kernels 310, 320, 330, and 340, the results of the convolution with the small kernel 340 need the data at the position 56 on the output data 440 of the convolution with the small kernel 340. The data at the position 56 on the output data 440 is selected and outputted by convolution performed by the aggregate convolution part 541.

Next, the following describes the structure and the operation of the aggregate convolution part 541 with reference to FIG. 9. The aggregate convolution part 541 has the aggregate kernel 380 of a kernel size 5×5 having a center 381, and a value of one is assigned to a position 382 of the aggregate kernel 380 while a value of zero is assigned to each of other positions.

The convolution of the aggregate kernel 380 and the output data 440 of the convolution with the small kernel 340 is computed as an output corresponding to the center 381 of the aggregate kernel 380 while having, for instance, the center of the aggregate kernel 380 move from the position 1 to the position 100 over the output data 440 of the convolution with the small kernel 340.

As shown in FIG. 9, when the center 381 of the aggregate kernel 380 is at the position 45 on the output data 440 of the convolution with the small kernel 340, convolution is performed between data in a range 441 on the output data 440 of the convolution with the small kernel 340 (the positions 23 to 27, 33 to 37, 43 to 47, 53 to 57, and 63 to 67) and the aggregate kernel 380 of the aggregate convolution part 541.

As a result, the data at the position 56 on the output data 440 of the convolution with the small kernel 340 is outputted as the result of the block 504.

In other words, by convolving the input data 400 with the small kernel 340, and by convolving the output data 440 which is the result of the convolution of the small kernel 340 with the aggregate kernel 380, the necessary result obtained from the convolution of the input data 400 and the small kernel 340 is outputted as the result of block 504.

By having the addition parts 560, 570, and 580 in the aggregate convolution layer 550 in FIG. 5 add up the results outputted by the blocks 501, 502, 503, and 504 as described above, it is possible to compute the convolution when the center 301 of the large kernel 300 shown in FIG. 3 is at the position 45 of the input data 400 using the results of the convolution with the decomposed small kernels 310, 320, 330, and 340. It should be noted that the output data 455 in FIG. 5 matches the output data 450 in FIG. 4, except for part of the periphery thereof.

As described, since the convolution layer containing the large kernel is converted into the convolution layer containing the combination of the plurality of small kernels decomposed from the large kernel and the aggregate convolution layer, optimization techniques related to a convolution of a kernel of a size 3×3 such as the Winograd optimization that can double the speed may be utilized for the convolution of the input data and each of the small kernels. Further, it is possible to make the most of circuits and implementations for high-speed execution of convolution layers containing a kernel of a size 3×3 and possible to further utilize a sparsity-leveraging acceleration mechanism that skips multiplication by a zero value if it is available. This allows for accelerated execution speed of convolutions.

As described above, according to the first example embodiment of the present invention, there can be provided a convolution layer conversion apparatus that contributes to improving the execution speed during the implementation of a convolution layer in a neural network model.

### Second Example Embodiment

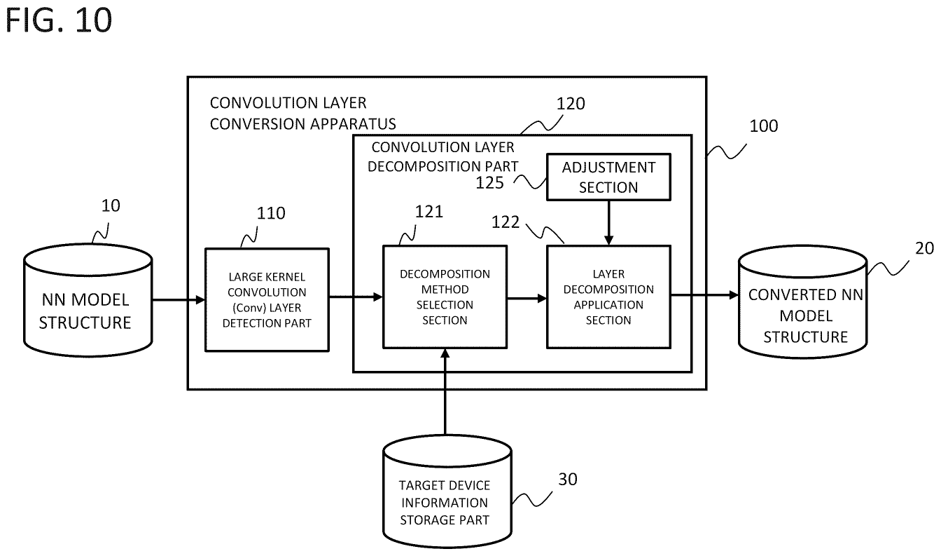

Next, the following describes a convolution layer conversion apparatus of a second example embodiment of the present invention with reference to the drawings. FIG. 10 is a drawing illustrating an example of the configuration of the convolution layer conversion apparatus according to the second example embodiment of the present invention. In FIG. 10, components with the same reference signs as those in FIG. 2 indicate the same components, and the descriptions thereof will be omitted.

With reference to FIG. 10, the convolution layer conversion apparatus 100 of the second example embodiment of the present invention includes the large kernel convolution (Conv) layer detection part 110 (convolution layer detection part) and the convolution layer decomposition part 120, and the convolution layer decomposition part 120 includes the decomposition method selection section 121, the layer decomposition application section 122, and an adjustment section 125. The convolution layer conversion apparatus 100 accepts the neural network (NN) model structure 10 as an input and outputs the converted neural network model structure 20. Further, to the decomposition method selection section 121 of the convolution layer decomposition part 120, the target device information storage part 30 is connected to provide target device information as an input.

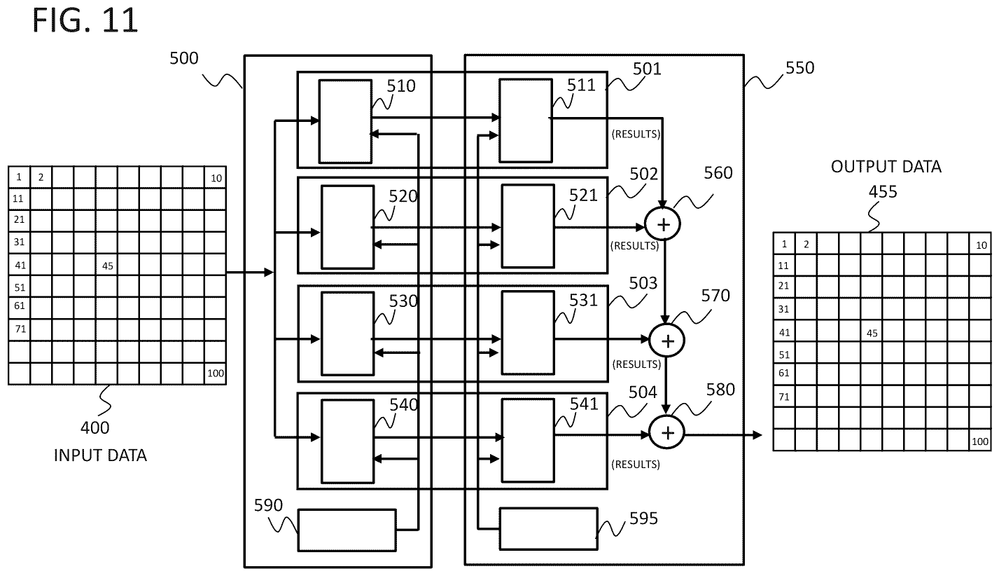

FIG. 11 is a drawing illustrating an example of the structure of a converted convolution layer of the second example embodiment of the present invention in which padding processing parts 590 and 595 are provided by the adjustment section 125 in the convolution layer 500 containing the combination of the plurality of small kernels and the aggregate convolution layer 550, respectively.

Next, the following describes the operation of the adjustment section 125 of the convolution layer decomposition part 120 with reference to the drawings. The adjustment section 125 has a function of providing in the convolution layer 500 containing the combination of the plurality of small kernels and in the aggregate convolution layer 550 shown in FIG. 11 the padding processing parts 590 and 595, respectively, that adjust the degree of mismatch between the output data 455 outputted by the aggregate convolution layer 550 and the output data 450, which is the convolution results of the convolution layer containing the large kernel 300 shown in FIG. 4. The padding processing parts 590 and 595 provided by the adjustment section 125 in the convolution layer 500 containing the combination of the plurality of small kernels and the aggregate convolution layer 550, respectively, execute the following operations in order to adjust the degree of mismatch with the output data 450.

Next, the operations of the padding processing part 590 and the padding processing part 595 provided by the adjustment section 125 in the convolution layer 500 containing the combination of the plurality of small kernels and the aggregate convolution layer 550, respectively, will be described.

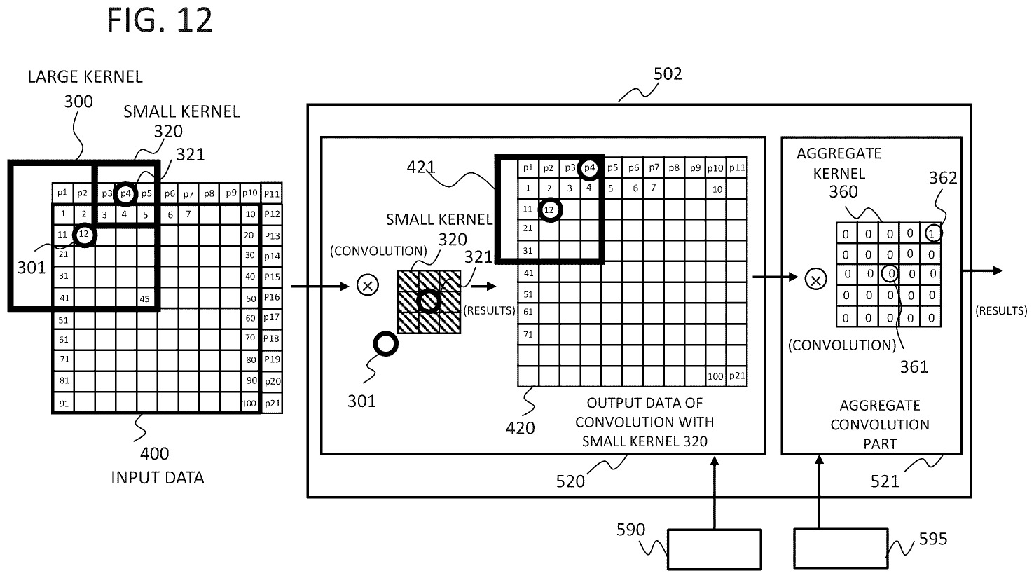

FIG. 12 is a drawing illustrating an example of the operation of the padding processing part 590 provided by the adjustment section of the second example embodiment of the present invention in the convolution layer 500 containing the combination of the small kernels and an example of the operation of the padding processing part 595 provided by the adjustment section in the aggregate convolution layer 550.

FIG. 12 shows an example of the operations of the padding processing parts 590 and 595 for the block 502 in FIG. 11. The same operations may be performed for the other blocks 501, 503, and 504.

As an example, the padding processing part 590 adds padding data with a value of zero at each of positions p1 to p21 for the positions 1 to 100 of the input data 400, as shown in FIG. 12.

Next, in a case where the convolution with the small kernel 320 when the center 301 of the large kernel 300 corresponds to the position 12 of the input data 400 is computed, the padding processing part 590 controls the small kernel convolution part 520 in such way that the small kernel convolution part 520 computes the convolution when the center 321 of the small kernel 320 is at the position p4. Specifically, the padding processing part 590 controls the small kernel convolution part 520 of the block 502 so that data at the positions 3, 4, and 5 on the input data 400 are convolved with three kernel elements in the bottom row of the small kernel 320 and the results are outputted to the position p4 on the output data 420 of the convolution with the small kernel 320.

In the case where the convolution with the small kernel 320 when the center 301 of the large kernel 320 corresponds to the position 12 of the input data 400 is computed, the padding processing part 595 controls the aggregate convolution part 521 so as to perform convolution with the data range 421 where the center 361 of the aggregate kernel 360 of the aggregate convolution part 521 is at the position 12 on the output data 420 of the convolution with the small kernel 320. Specifically, the data at the position p4 on the output data 420 of the convolution with the small kernel 320 is convolved with the value one at the position 362 of the aggregate kernel 360 of the aggregate convolution part 521, and the result thereof is outputted from the block 502.

By having the padding processing parts 590 and 595 perform padding processing on the top, bottom, left, and right edges of the periphery of the input data 400, similarly for the other blocks 501, 503, and 504 according to the positional relationship between the decomposed small kernel and the large kernel, the output data 455 in FIG. 11 can be made to match the output data 450 of the convolution results from the convolution layer containing the large kernel 300 shown in FIG. 4, even with respect to the periphery of the input data 400. Note that the number of added padding data changes depending on the size of the decomposed small kernel and the positional relationship between the undecomposed large kernel and the decomposed small kernel.

By having the adjustment section 125 of the convolution layer conversion apparatus 100 according to the second example embodiment of the present invention adjust the size of the padding data added and processed by the padding processing parts 590 and 595, it becomes possible to adjust the degree of mismatch with the results of the convolution with the large kernel with respect to the periphery of an image. Further, if a mismatch in the periphery of an image can be tolerated, the adjustment section 125 does not need to provide the padding processing parts 590 and 595.

### Third Example Embodiment

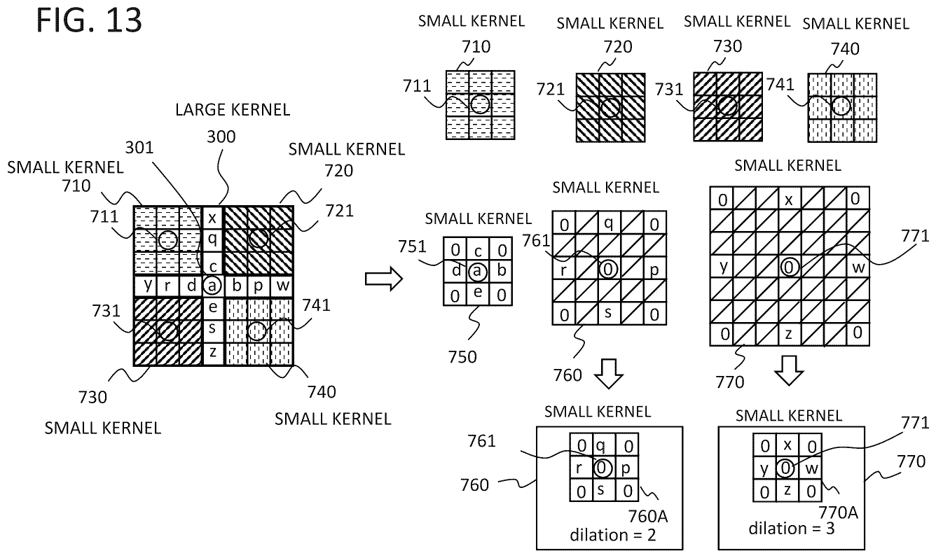

Next, with reference to the drawings, the following describes another decomposition method for decomposing a large kernel into a plurality of small kernels according to a third example embodiment of the present invention. FIG. 13 is a drawing illustrating another example of the decomposition method for decomposing a large kernel into a plurality of small kernels according to the third example embodiment of the present invention. In FIG. 13, components with the same reference signs as those in FIG. 3 indicate the same components, and the descriptions thereof will be omitted.

FIG. 13 shows an example of the decomposition method for decomposing the large kernel 300 of a kernel size 7×7 into seven small kernels 710, 720, 730, 740, 750, 760, and 770 according to the third example embodiment of the present invention. The small kernel 710 having a center 711, the small kernel 720 having a center 721, the small kernel 730 having a center 731, and the small kernel 740 having a center 741 are small kernels of a kernel size 3×3 corresponding to the top-left corner, the top-right corner, the bottom-left corner, and the bottom-right corner of the large kernel 300.

The small kernel 750 with a center 751 has the values at positions a, b, c, d, and e on the large kernel 300, at respective corresponding positions shown by positions a, b, c, d, and e on the small kernel 750, and has zero values at positions marked with 0s (zeros).

The small kernel 760 with a center 761 has the values at positions p, q, r, and s on the large kernel 300, at respective corresponding positions shown by positions p, q, r, and s on the small kernel 760, has zero values at positions marked with 0s (zeros), and does not have any value in parts marked with slashes.

The small kernel 770 with a center 771 has the values at positions w, x, y, and z on the large kernel 300, at respective corresponding positions shown by positions w, x, y, and z on the small kernel 770, has zero values at positions marked with 0s (zeros), and does not have any value in parts marked with slashes.

The small kernel 750 is a small kernel of a kernel size 3×3.

The small kernel 760 is a small kernel of a kernel size 5×5, but by setting dilation to two for the convolution, it can be expressed as a small kernel 760A, having the center 761, of a kernel size 3×3, with the slashed parts removed.

The small kernel 770 is a small kernel of a kernel size 7×7, but by setting dilation to three for the convolution, it can be expressed as a small kernel 770A, having the center 771, of a kernel size 3×3, with the slashed parts removed.

As described above, all the small kernels 710, 720, 730, 740, 750, 760, and 770 of the third example embodiment can be expressed as small kernels of a kernel size 3×3 by appropriately setting dilation for the convolution.

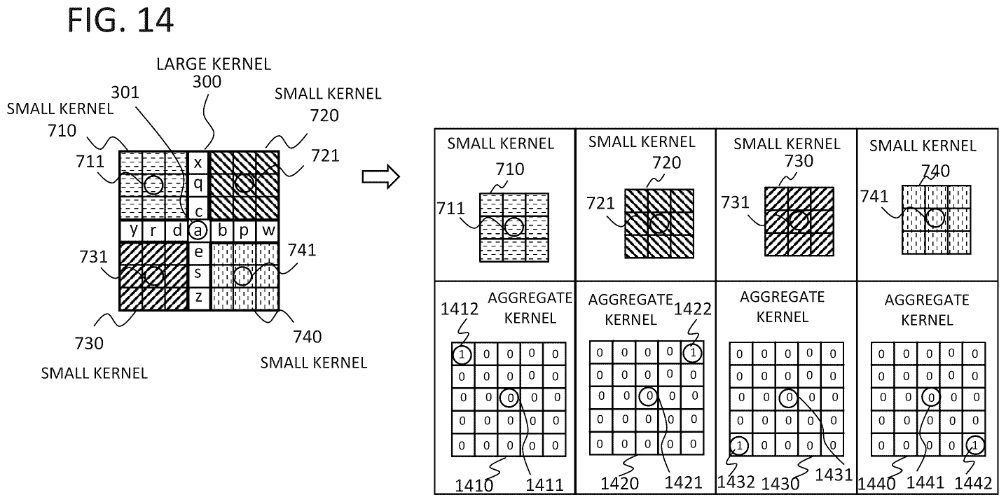

FIG. 14 is a drawing illustrating examples of the small kernels 710, 720, 730, and 740 of a convolution layer containing a combination of the decomposed small kernels and aggregate kernels 1410, 1420, 1430, and 1440 of an aggregate convolution layer corresponding to the small kernels 710, 720, 730, and 740 according to the third example embodiment of the present invention.

The aggregate kernels 1410, 1420, 1430, and 1440 are, for instance, kernels of a size 5×5 and have centers 1411, 1421, 1431, and 1441, respectively.

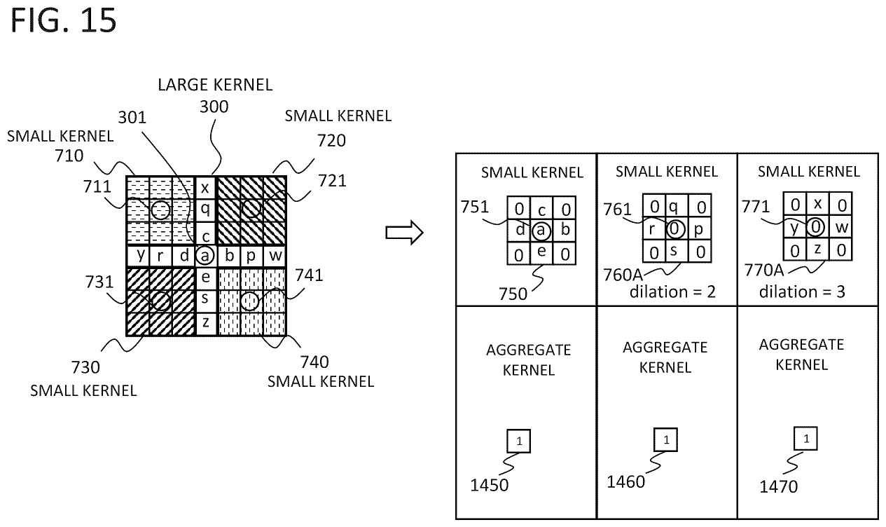

Further, FIG. 15 is a drawing illustrating examples of the small kernels 750, 760 (760A; dilation=2), and 770 (770A; dilation=3) of the convolution layer containing the combination of the decomposed small kernels and aggregate kernels 1450, 1460, and 1470 of the aggregate convolution layer corresponding to the small kernels 750, 760, and 770 according to the third example embodiment of the present invention. Sizes of the aggregate kernels 1450, 1460, and 1470 are, for instance, a size 1×1.

In order to compute the convolution of the input data 400 with the large kernel 300 using the convolution of the input data 400 with each of the small kernels 710, 720, 730, 740, 750, 760 (760A; dilation=2), and 770 (770A; dilation=3), the convolution results of the small kernels 710, 720, 730, and 740 must be obtained from the positions corresponding to the centers 711, 721, 731, and 741 of the small kernels 710, 720, 730, and 740 with respect to the center 301 of the large kernel 300, respectively, and then the results need to be added together.

The necessary convolution results of the small kernels 710, 720, 730, and 740 can be obtained by convolving the result of the convolution between the input data and each of the small kernels 710, 720, 730, and 740 with each of the aggregate kernels 1410, 1420, 1430, and 1440 in FIG. 14.

The necessary convolution results of the small kernels 750, 760, and 770 can be obtained by convolving the result of the convolution between the input data and each of the small kernels 750, 760, and 770 with each of the aggregate kernels 1450, 1460, and 1470 in FIG. 15. Note that sizes of the aggregate kernels 1450, 1460, and 1470 are, for instance, a size 1×1. In other words, since the center 301 of the large kernel 300 matches the centers 751, 761, and 771 of the small kernels 750, 760, and 770, the convolution with the aggregation kernels 1450, 1460, and 1470 is unnecessary.

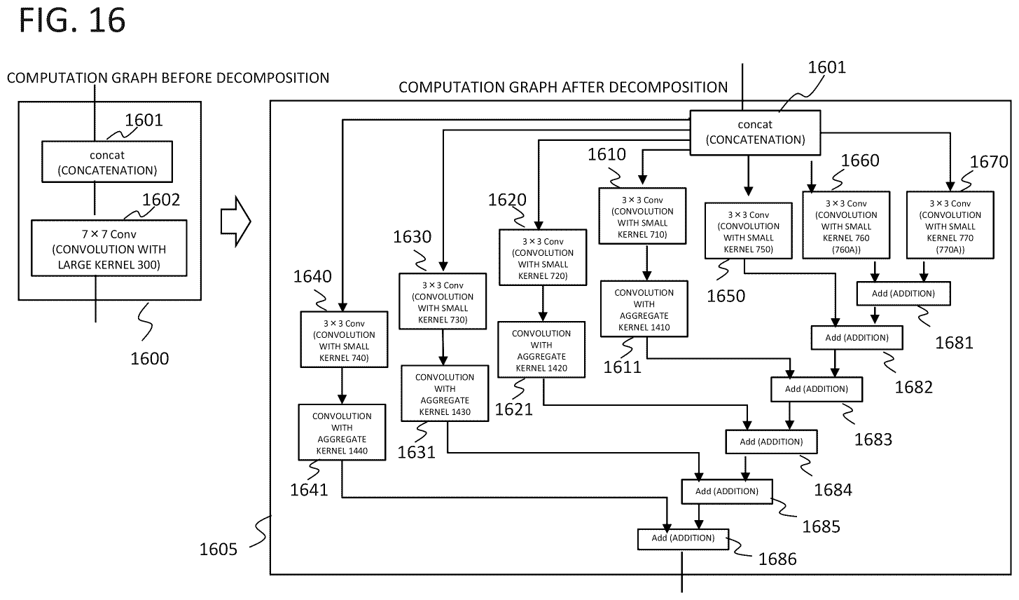

FIG. 16 is a drawing illustrating examples of computation graphs before and after the decomposition of the large kernel 300 according to the third example embodiment of the present invention. The computation graph 1600 of the undecomposed large kernel 300 on the left side of FIG. 16 includes a convolution 1602 of the large kernel 300 of a size 7×7. Meanwhile, the computation graph 1605 after the decomposition on the right side includes additions 1681 to 1686 that add up the computation results of convolutions 1610, 1620, 1630, and 1640 that execute the convolutions with the small kernels 710, 720, 730, and 740 and aggregate convolutions 1611, 1621, 1631, and 1641 that execute the convolutions with the aggregate kernels 1410, 1420, 1430, and 1440, each of which corresponds to the result of the convolution with each of the small kernels, and the computation results of convolutions 1650, 1660, and 1670 that execute the convolutions with the small kernels 750, 760, and 770. According to the configuration of FIG. 16, it is possible to execute the convolutions with the decomposed small kernels by sequentially adding up each computation result.

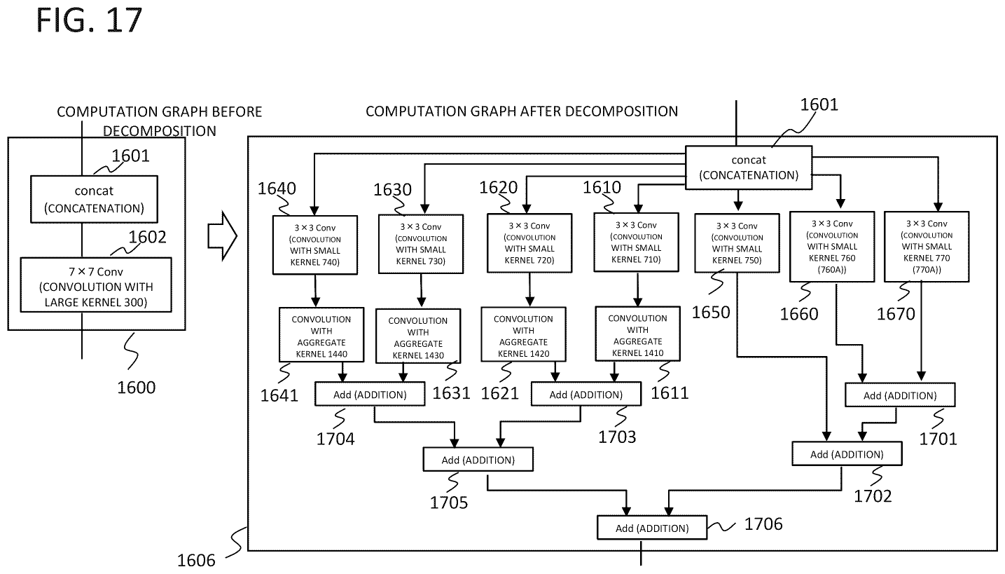

FIG. 17 is a drawing illustrating another example of computation graphs before and after the decomposition of the large kernel 300 according to the third example embodiment of the present invention. The computation graph 1600 of the undecomposed large kernel 300 on the left side of FIG. 17 is the same as the computation graph 1600 of the undecomposed large kernel 300 on the left side of FIG. 16. Meanwhile, in the computation graph 1606 after the decomposition on the right side, the computation results of the convolutions 1610, 1620, 1630, and 1640 that execute the convolutions with the small kernels 710, 720, 730, and 740 and the aggregate convolutions 1611, 1621, 1631, and 1641 that execute the convolutions with the aggregate kernels 1410, 1420, 1430, and 1440, each of which corresponds to the result of the convolution with each of the small kernels, and the computation results of the convolutions 1650, 1660, and 1670 that execute the convolutions with the small kernels 750, 760, and 770 are computed in parallel, and the results are added in parallel by additions 1701 to 1706. As a result, the convolutions with the decomposed small kernels can be executed.

As described, because the convolution layer containing the large kernel 300 is converted into the convolution layer containing the combination of the plurality of small kernels 710, 720, 730, 740, 750, 760, and 770 and the aggregate convolution layer, optimization techniques related to convolution of kernels of a size 3×3 such as, for example, the Winograd optimization that can double the speed may be utilized for a convolution of the input data and each of the small kernels. Further, it is possible to make the most of circuits and implementations for high-speed execution of convolution layers containing kernels of a size 3×3 and possible to further utilize a sparsity-leveraging acceleration mechanism that skips multiplication by a zero value if it is available. This allows for accelerated execution speed of convolutions.

### Fourth Example Embodiment

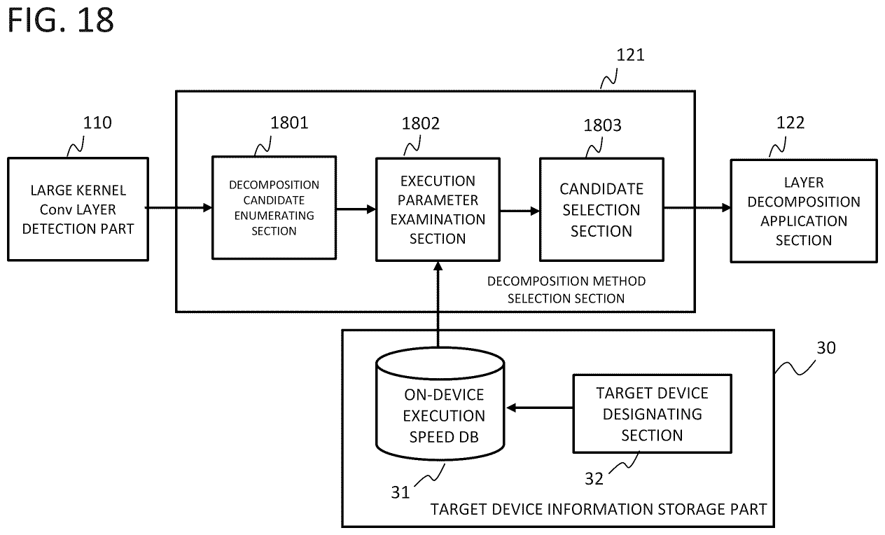

Next, the following describes a fourth example embodiment of the present invention with reference to the drawings. FIG. 18 is a drawing illustrating an example of the configuration of a decomposition method selection section of a convolution layer decomposition part of a convolution layer conversion apparatus according to the fourth example embodiment of the present invention. The decomposition method selection section 121 shown in FIG. 18 illustrates an example of the configuration of the decomposition method selection section 121 of the convolution layer decomposition part 120 of the convolution layer conversion apparatus 100, shown in FIG. 2, according to the first example embodiment of the present invention. In FIG. 18, components with the same reference signs as those in FIG. 2 indicate the same components, and the descriptions thereof will be omitted.

The decomposition method selection section 121 of the fourth example embodiment of the present invention includes a decomposition candidate enumerating section 1801, an execution parameter examination section 1802 for each candidate, and a candidate selection section 1803. The target device information storage part 30 is connected to the execution parameter examination section 1802 for each candidate. The target device information storage part 30 includes an on-device execution speed database 31 and a target device designating section 32.

The execution speed of convolution changes depending on the computational acceleration method employed by the device executing the convolution. For instance, in convolutions of kernel of a size 3×3, optimization techniques related to convolution of kernels of a size 3×3 such as, for example, the Winograd optimization that can double the speed can be utilized. Further, it is possible to make the most of circuits and implementations for high-speed execution of convolution layers containing kernels of a size 3×3 and possible to further utilize a sparsity-leveraging acceleration mechanism that skips multiplication by a zero value if it is available. This allows for accelerated execution speed of convolutions.

However, because the computational acceleration methods employed by devices executing convolution can vary from one device to another, for instance, the execution speed of running on each device a convolution of a convolution layer containing a combination of a plurality of small kernels obtained by decomposing a large kernel of a size 7×7 into kernels of a size 4×4 and kernels of a size of 3×3 as a decomposition candidate, and the execution speed of running on each device a convolution of a convolution layer containing a combination of a plurality of small kernels obtained by decomposing a large kernel of a size 7×7 into a kernel of a size 3×3, a kernel of a size 3×3 with a dilation of two, and a kernel of a size 3×3 kernel with a dilation of three as another decomposition candidate are measured, and the execution speed information corresponding to each device is stored in the on-device execution speed database 31 as the target device information in advance. Note that decomposition candidates of which the execution speeds are measured are not limited to the examples above, and other sizes or types of kernel combinations may also be used. Further, the on-device execution speed database 31 may store the memory usage information indicating the memory usage of running a convolution layer containing a combination of a plurality of small kernels on a target device.

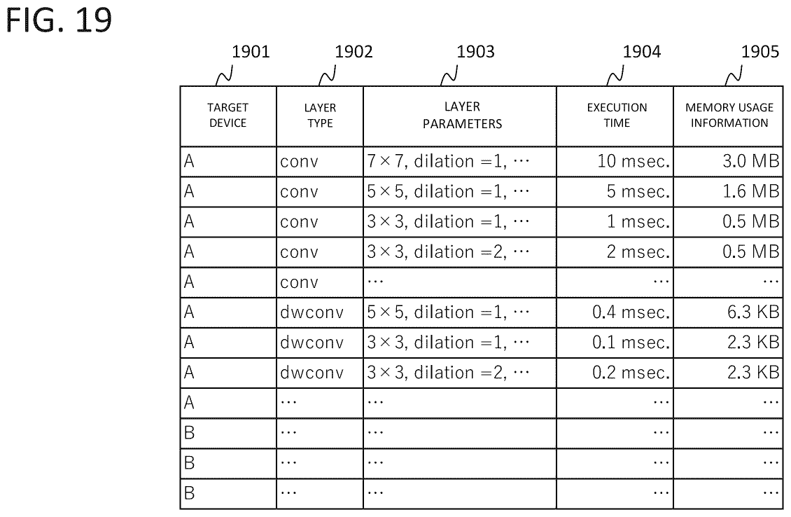

FIG. 19 shows an example of the target device information stored in the on-device execution speed database 31. With reference to FIG. 19, a column 1901 indicates a target device, a column 1902 indicates a layer type, a column 1903 indicates layer parameters, a column 1904 indicates an execution time, and a column 1905 indicates memory usage information. The execution time can be obtained in advance by executing the process indicated by each of the layer parameters on the target device and measuring a time required for a process. Execution speed information is indicated by the execution time in the column 1904 and a less execution time corresponds to execution speed information indicating a faster execution speed.

Next, with reference to FIG. 18, the following describes the operation of the decomposition method selection section 121 of the convolution layer decomposition part 120 of the convolution layer conversion apparatus 100 according to the fourth example embodiment of the present invention. In FIG. 18, the decomposition candidate enumerating section 1801 of the decomposition method selection section 121 receives as an input a convolution layer containing a large kernel of a predetermined size or larger detected by the large kernel convolution layer detection part 110 in the neural network (NN) model structure 10 provided as an input.

The decomposition candidate enumerating section 1801 enumerates decomposition candidates to be decomposed from the convolution layer containing the large kernel of, for instance, a size 7×7 provided as an input into a convolution layer containing a combination of a plurality of small kernels. Examples of decomposition candidates are described in the example embodiments above; however, the decomposition candidates are not limited thereto and other sizes or types of kernel combinations may also be used. The enumerated decomposition candidates are sent to the execution parameter examination section 1802 for each candidate.

Meanwhile, the target device specifying section 32 of the target device information storage part 30 designates a target device that executes convolution. For the target device designated by the target device specifying section 32, the on-device execution speed database (DB) 31 sends to the execution parameter examination section 1802 for each candidate the stored execution speed information indicating the execution speed of running a convolution layer containing a combination of a plurality of small kernels (a candidate decomposed using the decomposition method) on the target device. If the memory usage information is stored, the database sends to the execution parameter examination section 1802 for each candidate the memory usage information indicating the memory usage of running a convolution layer containing a combination of a plurality of small kernels (a candidate decomposed using the decomposition method) on the target device.

The execution parameter examination section 1802 for each candidate examines the execution speed of each enumerated decomposition candidate using the execution speed information for each decomposition candidate and designates the fastest decomposition candidate.

The candidate selection section 1803 informs the layer decomposition application section 122 of the fastest decomposition candidate designated.

As a result, the layer decomposition application section 122 is able to decompose the convolution layer using the decomposition candidate that can execute the convolution the fastest on the specified device.

Further, if the memory usage information is also sent to the execution parameter examination section 1802 for each candidate, the memory usage information may be referred to in addition to the execution speed information, and a decomposition candidate having both the execution speed information and the memory usage information meeting a predetermined selection criterion may be selected. For instance, a decomposition candidate having an execution speed equal to or faster than a predetermined value and a memory usage equal to or less than a predetermined value may be selected. Alternatively, a decomposition candidate with the least memory usage may be selected on the basis of the memory usage information.

Because the decomposition method selection section 121 of the fourth example embodiment of the present invention can select a decomposition candidate that can execute convolution at the fastest speed on a specified device, the convolution layer conversion apparatus 100 shown in FIG. 2 is able to convert a convolution layer containing a large kernel into a convolution layer containing a combination of a plurality of small kernels that can be executed at the fastest speed on the designated device and an aggregate convolution layer that aggregates the convolution results from the convolution layer containing the combination of the plurality of small kernels and output the neural network model structure 20 converted from the convolution layer containing the large kernel.

Further, it is possible to select a decomposition candidate having both the execution speed information and the memory usage information meeting a predetermined selection criterion, and it is possible to convert a convolution layer containing a large kernel into a convolution layer containing a combination of a plurality of small kernels and an aggregate convolution layer that aggregates the convolution results from the convolution layer containing the combination of the plurality of small kernels and output the neural network model structure 20 in which the convolution layer containing the large kernel is converted.

Moreover, it is possible to select a decomposition candidate with the least memory usage on the basis of the memory usage information, and convert a convolution layer containing a large kernel into a convolution layer containing a combination of a plurality of small kernels and an aggregate convolution layer that aggregates the convolution results from the convolution layer containing the combination of the plurality of small kernels and output the neural network model structure 20 in which the convolution layer containing the large kernel is converted.

While each example embodiment of the present invention has been described, it is to be understood that the present invention is not limited to the example embodiments above and that further modifications, replacements, and adjustments may be added without departing from the basic technical concept of the present invention. For instance, the system configuration, the configuration of each element, and the expression of the message shown in each drawing are examples to facilitate understanding of the present invention and are not limited to the configurations shown in these drawings. Further, in the following description, “A and/or B” signifies at least one of A and B.

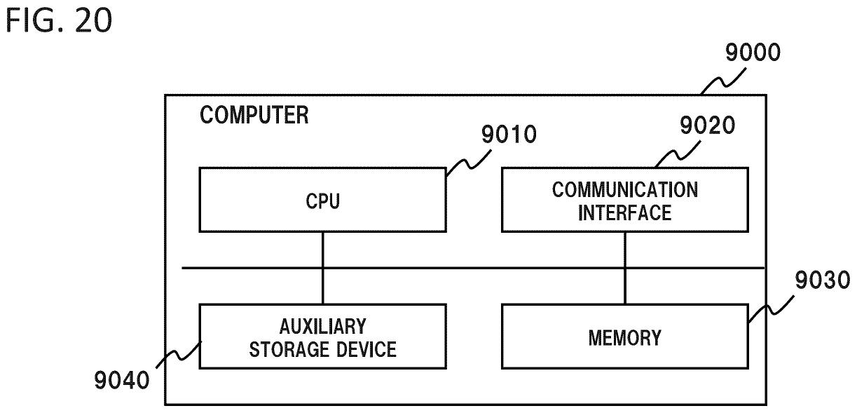

Further, the procedures described in the first to the fourth example embodiments above can be realized by a program causing a computer (9000 in FIG. 20) that functions as the convolution layer conversion apparatus to realize the functions as the convolution layer conversion apparatus. Such a computer is exemplified by a configuration shown in FIG. 20 including a CPU (Central Processing Unit) 9010, a communication interface 9020, a memory 9030, and an auxiliary storage device 9040. In other words, the CPU 9010 in FIG. 20 executes the convolution layer conversion program and updates each calculation parameter held by the auxiliary storage device 9040.

The memory 9030 is a RAM (Random Access Memory), a ROM (Read-Only Memory), and the like.

In other words, each part (each processing means or function) of the convolution layer conversion apparatuses described in the first to the fourth example embodiments above can be realized by a computer program causing the processor of the computer to execute each of the processes described above using the hardware thereof.

Finally, preferred modes of the present invention will be summarized.

### Mode 1

(Refer to the convolution layer conversion apparatus according to the first aspect.)

### Mode 2

In the convolution layer conversion apparatus according to Mode 1, it is preferable that the convolution layer decomposition part further includes an adjustment section that provides in each of the convolution layer containing the combination of the plurality of small kernels and the aggregate convolution layer a padding processing part that adjusts a degree of mismatch between aggregate results of the aggregate convolution layer and convolution results of the convolution layer containing the large kernel.

### Mode 3

In the convolution layer conversion apparatus according to Mode 1 or 2, it is preferable that the convolution layer decomposition part includes:
a decomposition method selection section that refers to target device information to select a decomposition method for decomposing the large kernel into the plurality of small kernels; and
a layer decomposition application section that generates the convolution layer containing the combination of the plurality of small kernels and the aggregate convolution layer according to the selected decomposition method.

### Mode 4

In the convolution layer conversion apparatus according to Mode 3, it is preferable that the decomposition method selection section includes:
a decomposition candidate enumerating section that enumerates decomposition candidates of the decomposition method;
an execution parameter examination section that refers to the target device information for each of the enumerated decomposition candidates to examine execution parameters on a target device; and
a decomposition candidate selection section that selects a decomposition candidate with the optimal execution parameters.

### Mode 5

In the convolution layer conversion apparatus according to Mode 4, it is preferable that the target device information includes execution speed information indicating an execution speed when the convolution layer containing the combination of the plurality of small kernels is running on the target device or memory usage information indicating the memory usage when the convolution layer containing the combination of the plurality of small kernels is running on the target device,
the execution parameter examination section refers to the execution speed information for each enumerated decomposition candidate to examine the execution speed thereof on the target device or refers to the memory usage information for each enumerated decomposition candidate to examine memory usage thereof on the target device, and
the decomposition candidate selection section selects a decomposition candidate having at least one of the execution speed or the memory usage thereof meeting a predetermined selection criterion.

### Mode 6

In the convolution layer conversion apparatus according to Mode 5, it is preferable that the predetermined selection criterion for the execution speed is a fastest execution speed, and the predetermined selection criterion for the memory usage is a smallest memory usage.

### Mode 7

In the convolution layer conversion apparatus according to Mode 5, it is preferable that the decomposition candidate selection section selects a decomposition candidate having both the execution speed and the memory usage thereof meeting a predetermined selection criterion.

### Mode 8

In the convolution layer conversion apparatus according to Mode 7, it is preferable that the predetermined selection criterion for the execution speed is a speed equal to or higher than a predetermined value, and the predetermined selection criterion for the memory usage is a usage equal to or smaller than a predetermined value.

### Mode 9

(Refer to the convolution layer conversion method according to the second aspect.)

### Mode 10

(Refer to the program according to the third aspect.)

Further, as Mode 1, Modes 9 and 10 can be expanded into Modes 2 to 8.

Further, the disclosure of each Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select a wide variety of the disclosed elements (including the individual elements of the individual claims, the individual elements of the individual example embodiments or examples, and the individual elements of the individual figures) within the scope of the disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned.

### REFERENCE SIGNS LIST

10: neural network (NN) model structure
20: converted neural network (NN) model structure
30: target device information storage part
31: on-device execution speed database (DB)
32: target device designating section
100: convolution layer conversion apparatus
110: large kernel convolution (Conv) layer detection part
120: convolution layer decomposition part
121: decomposition method selection section
122: layer decomposition application section
125: adjustment section
300: large kernel
301: center
310, 320, 330, 340: small kernel
311, 321, 331, 341: center
350, 360, 370, 380: aggregate kernel
351, 361, 371, 381: center
400: input data
450, 455: output data
500: convolution layer containing a combination of a plurality of small kernels
501, 502, 503, 504: block
510, 520, 530, 540: small kernel convolution part
511, 521, 531, 541: aggregate convolution part
550: aggregate convolution layer
560, 570, 580: addition part
590, 595: padding processing part
710, 720, 730, 740, 750: small kernel
760, 760A, 770, 770A: small kernel
711, 721, 731, 741: center
751, 761, 771: center
1410, 1420, 1430, 1440, 1450, 1460, 1470: aggregate kernel
1411, 1421, 1431, 1441: center
1600: computation graph before decomposition
1605: computation graph after decomposition
1606: computation graph after decomposition
1801: decomposition candidate enumerating section
1802: execution parameter examination section
1803: candidate selection section
9000: computer
9010: CPU
9020: communication interface
9030: memory
9040: auxiliary storage device

What is claimed is:

1. A convolution layer conversion apparatus, comprising:
at least a processor; and
a memory in circuit communication with the processor,
wherein the processor is configured to execute program instructions stored in the memory to perform:
detecting a convolution layer containing a large kernel whose kernel size is a predetermined size or larger in a neural network model structure provided as an input; and
converting the convolution layer containing the large kernel into a convolution layer containing a combination of a plurality of small kernels whose kernel sizes are smaller than the predetermined size decomposed from the large kernel and an aggregate convolution layer that aggregates convolution results from the convolution layer containing the combination of the plurality of small kernels, and outputs a neural network model structure in which the convolution layer containing the large kernel is converted.

2. The convolution layer conversion apparatus according to claim 1, wherein the processor is configured to execute the program instructions to implement: providing in each of the convolution layer containing the combination of the plurality of small kernels and the aggregate convolution layer a padding processing part that adjusts a degree of mismatch between aggregate results of the aggregate convolution layer and convolution results of the convolution layer containing the large kernel.

3. The convolution layer conversion apparatus according to claim 1, wherein
the processor is configured to execute the program instructions to implement:
referring to target device information to select a decomposition method for decomposing the large kernel into the plurality of small kernels; and
generating the convolution layer containing the combination of the plurality of small kernels and the aggregate convolution layer according to the selected decomposition method.

4. The convolution layer conversion apparatus according to claim 3, wherein
the processor is configured to execute the program instructions to implement:
enumerating decomposition candidates of the decomposition method;
referring to the target device information for each of the enumerated decomposition candidates to examine execution parameters on a target device; and
selecting a decomposition candidate with the optimal execution parameters.

5. The convolution layer conversion apparatus according to claim 4, wherein
the target device information comprises execution speed information indicating an execution speed when the convolution layer containing the combination of the plurality of small kernels is running on the target device or memory usage information indicating the memory usage when the convolution layer containing the combination of the plurality of small kernels is running on the target device, and
wherein the processor is configured to execute the program instructions to implement:
referring to the execution speed information for each enumerated decomposition candidate to examine the execution speed thereof on the target device or refers to the memory usage information for each enumerated decomposition candidate to examine memory usage thereof on the target device, and
selecting a decomposition candidate having at least one of the execution speed or the memory usage thereof meeting a predetermined selection criterion.

6. The convolution layer conversion apparatus according to claim 5, wherein the predetermined selection criterion for the execution speed is a fastest execution speed, and the predetermined selection criterion for the memory usage is a smallest memory usage.

7. The convolution layer conversion apparatus according to claim 5, wherein the processor is configured to execute the program instructions to implement: selecting a decomposition candidate having both the execution speed and the memory usage thereof meeting a predetermined selection criterion.

8. The convolution layer conversion apparatus according to claim 7, wherein the predetermined selection criterion for the execution speed is a speed equal to or higher than a predetermined value, and the predetermined selection criterion for the memory usage is a usage equal to or smaller than a predetermined value.

9. A convolution layer conversion method executed by a computer comprising a processor and a storage device, the convolution layer conversion method comprising:
detecting a convolution layer containing a large kernel whose kernel size is a predetermined size or larger in a neural network model structure provided as an input; and
converting the convolution layer containing the large kernel into a convolution layer containing a combination of a plurality of small kernels whose kernel sizes are smaller than the predetermined size decomposed from the large kernel and an aggregate convolution layer that aggregates convolution results from the convolution layer containing the combination of the plurality of small kernels and outputting a neural network model structure in which the convolution layer containing the large kernel is converted.

10. A computer-readable non-transitory recording medium recording a program, wherein the program causes a computer to execute:
a process of detecting a convolution layer containing a large kernel whose kernel size is a predetermined size or larger in a neural network model structure provided as an input; and
a process of converting the convolution layer containing the large kernel into a convolution layer containing a combination of a plurality of small kernels whose kernel sizes are smaller than the predetermined size decomposed from the large kernel and an aggregate convolution layer that aggregates convolution results from the convolution layer containing the combination of the plurality of small kernels and outputting a neural network model structure in which the convolution layer containing the large kernel is converted.

11. The convolution layer conversion method according to claim 9, further comprising:
providing in each of the convolution layer containing the combination of the plurality of small kernels and the aggregate convolution layer a padding processing part that adjusts a degree of mismatch between aggregate results of the aggregate convolution layer and convolution results of the convolution layer containing the large kernel.

12. The convolution layer conversion method according to claim 9, further comprising:
referring to target device information to select a decomposition method for decomposing the large kernel into the plurality of small kernels; and
generating the convolution layer containing the combination of the plurality of small kernels and the aggregate convolution layer according to the selected decomposition method.

13. The convolution layer conversion method according to claim 12, further comprising:
enumerating decomposition candidates of the decomposition method;
referring to the target device information for each of the enumerated decomposition candidates to examine execution parameters on a target device; and
selecting a decomposition candidate with the optimal execution parameters.

14. The convolution layer conversion method according to claim 13, wherein
the target device information comprises execution speed information indicating an execution speed when the convolution layer containing the combination of the plurality of small kernels is running on the target device or memory usage information indicating the memory usage when the convolution layer containing the combination of the plurality of small kernels is running on the target device, and
the convolution layer conversion method further comprising:
referring to the execution speed information for each enumerated decomposition candidate to examine the execution speed thereof on the target device or refers to the memory usage information for each enumerated decomposition candidate to examine memory usage thereof on the target device, and
selecting a decomposition candidate having at least one of the execution speed or the memory usage thereof meeting a predetermined selection criterion.

15. The convolution layer conversion method according to claim 14, wherein the predetermined selection criterion for the execution speed is a fastest execution speed, and the predetermined selection criterion for the memory usage is a smallest memory usage.

16. The medium according to claim 10, wherein the program further causes a computer to execute:
a process of providing in each of the convolution layer containing the combination of the plurality of small kernels and the aggregate convolution layer a padding processing part that adjusts a degree of mismatch between aggregate results of the aggregate convolution layer and convolution results of the convolution layer containing the large kernel.

17. The medium according to claim 10, wherein the program further causes a computer to execute:
a process of referring to target device information to select a decomposition method for decomposing the large kernel into the plurality of small kernels; and
a process of generating the convolution layer containing the combination of the plurality of small kernels and the aggregate convolution layer according to the selected decomposition method.

18. The medium according to claim 17, wherein the program further causes a computer to execute:
a process of enumerating decomposition candidates of the decomposition method;
a process of referring to the target device information for each of the enumerated decomposition candidates to examine execution parameters on a target device; and
a process of selecting a decomposition candidate with the optimal execution parameters.

19. The medium according to claim 18, wherein
the target device information comprises execution speed information indicating an execution speed when the convolution layer containing the combination of the plurality of small kernels is running on the target device or memory usage information indicating the memory usage when the convolution layer containing the combination of the plurality of small kernels is running on the target device, and
wherein the program further causes a computer to execute:
a process of referring to the execution speed information for each enumerated decomposition candidate to examine the execution speed thereof on the target device or refers to the memory usage information for each enumerated decomposition candidate to examine memory usage thereof on the target device, and
a process of selecting a decomposition candidate having at least one of the execution speed or the memory usage thereof meeting a predetermined selection criterion.

20. The medium according to claim 19, wherein the predetermined selection criterion for the execution speed is a fastest execution speed, and the predetermined selection criterion for the memory usage is a smallest memory usage.
